(19) United States
(12) Patent Application Publication
(10) Pub. No.: US 2022/0292899 A1
(43) Pub. Date: Sep. 15, 2022

(54) MULTI-FACTOR FACILITY ACCESS AND CONTROL

(71) Applicant: KLOEE, LCC, East Longmeadow, MA (US)

(72) Inventor: David Thor, Longmeadow, MA (US)

(73) Assignee: Kloee, LLC, East Longmeadow, MA (US)

(21) Appl. No.: 17/234,677

(22) Filed: Apr. 19, 2021

Related U.S. Application Data
(60) Provisional application No. 63/012,084, filed on Apr. 18, 2020.

(51) Int. Cl. G07C 9/00; G07C 9/27

(52) U.S. Cl. CPC G07C 9/00309; G07C 9/27; G07C 2009/00412; G07C 2009/00507

(57) ABSTRACT

An access control method comprises providing a handheld mobile wireless device that includes a user key uniquely associated with a user, and a facility communication device that transmits a facility key uniquely associated with the facility. The mobile device receives the transmitted facility key and retransmits the received facility key and the user key to a remote premise control server, which authenticates the received keys. The server transmits an access control command if the keys authenticate. The server regularly updates the facilities key and transmits an updated facility key to the facilities communication device.

### CROSS REFERENCE TO RELATED APPLICATIONS

This application claims the benefit of U.S. Provisional Patent Application Ser. No. 63/0120,846 filed Apr. 18, 2020, which is hereby incorporated by reference.

### BACKGROUND OF THE INVENTION

### 1. Technical Field

This disclosure relates generally to access control and/or facility control, more particularly, to facility access and/or control that employs multi-factor authentication.

### 2. Background Information

Automated access control that allows a trusted person access to a facility (e.g., a building, an enclosed area, a home, a piece of operating equipment, et cetera) is well known. Such systems can be configured to grant the trusted person access at specific times and may be quickly reconfigured to revoke access or change access. One such system includes sending a visitor an email with a QR code, which is also sent to a door controller. When the visitor presents the QR code to a door station, the door station reads and sends the imaged QR code to the door controller that compares the imaged QR code with the QR code previously stored in the door controller, and if verified the controller opens the door.

Other access control authentication techniques are known, such as for example knowledge factors (e.g., a password or PIN), possession factors (e.g., an ID card, a security token, a cellphone, a mobile device or smartphone app), inherence factors (e.g., a biometric), location factors (e.g., authentication only allowed by certain devices at particular confirmed location), and time factors (e.g., authentication only allowed during certain time windows).

An improved technique for facility access and/or control is needed.

### BRIEF DESCRIPTION OF THE DRAWINGS

FIG. 1 is a pictorial illustration of a multi-factor facility access and control system.

FIG. 2 is a simplified pictorial illustration of a portion of a packetized embodiment of the user key including a user ID field, which is transmitted by a mobile device.

FIG. 3 is a simplified block diagram illustration of an embodiment of a facility key communicator.

### DETAILED DESCRIPTION

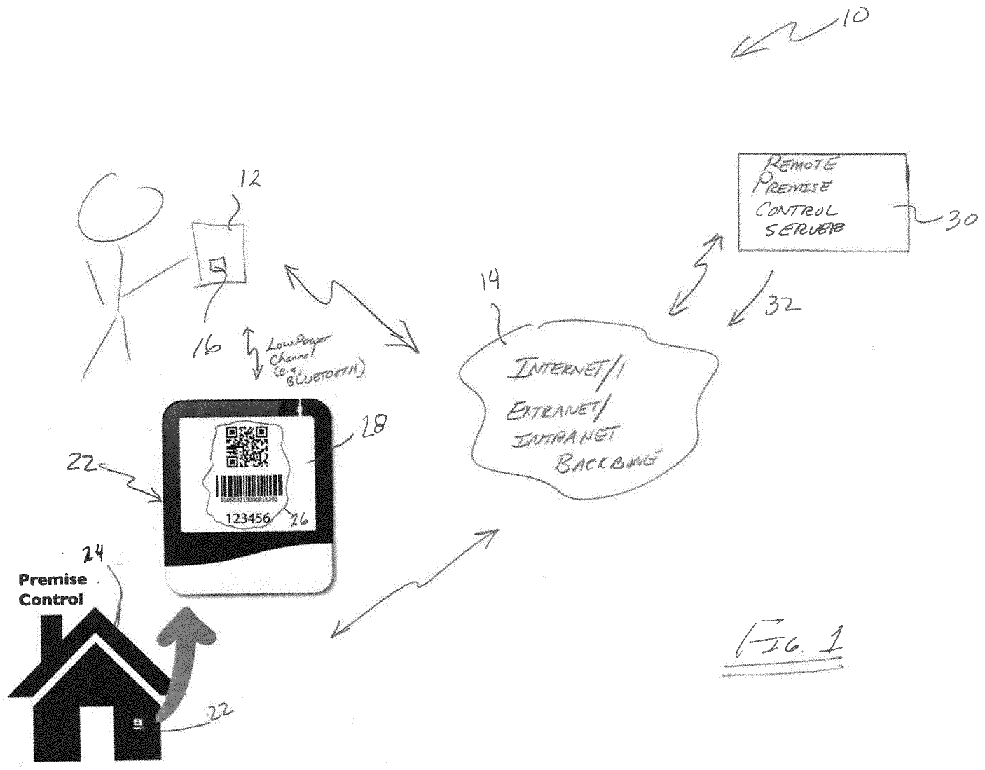

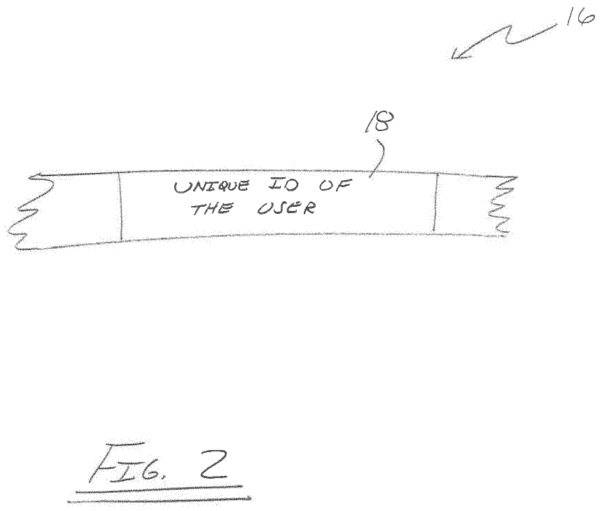

FIG. 1 is a pictorial illustration of a multi-factor facility access and control system 10. A mobile device 12 (e.g., a smart phone or other wireless device such as a tablet or smart watch) is associated with a user and allows the user to access a communication network 14. The communication network 14 may be a packet switched network, such as for example, the internet, an extranet, an intranet, et cetera. The mobile device 12 holds a user key 16 that comprises a unique ID for the user (e.g., one or more of the MEI, MEID, ESN or IMSI number, the MAC address, the serial number of the mobile device) or the mobile number assigned by the carrier as a proxy, or a token obtained via prior authentication via a smart app on the device. The user key 16 can come in many forms and may be stored on the mobile device 12, or is accessible to the mobile device via the network 14. FIG. 2 is a simplified pictorial illustration of a portion of a packetized embodiment of the user key 16 including a user ID field 18, which is transmitted by the mobile device.

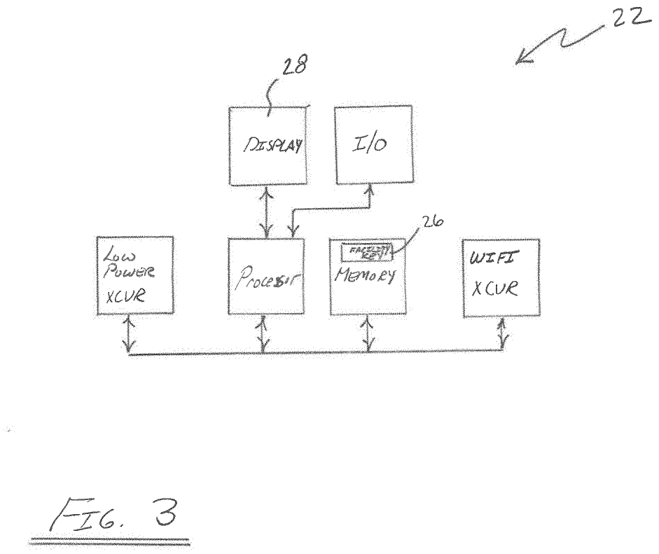

Referring to FIG. 1, the system 10 includes a facility key communicator 22 located at a facility 24 (e.g., a building, an enclosed area, a home, or even a piece of operating equipment, et cetera). The facility key communicator 22 wirelessly and/or visually provides a facility key 26. The facility key communicator 22 may include a small local display 28 mounted at the facility point of service (e.g., near a garage door, door entry point, et cetera to which access or control is being sought). The display 28 may visually present the facility key 26 as one or more for example of a (i) QR code, (ii) bar code, or (iii) numeric code. For added security, the facility key 26 is regularly updated/modified, and thus the display content is modified accordingly as the facility key 26 is updated. As an alternative to or in addition to displaying the facility key 26, the facility key communicator 22 may wirelessly transmit the facility key 26 (e.g., via BLUETOOTH® wireless technology and/or Wi-Fi). The facility key communicator 22 may be battery powered or hard wired to power. FIG. 3 is a simplified block diagram illustration of an embodiment of the facility key communicator 22. An example how the system and method of the present disclosure operate shall now be presented.

Referring still to FIGS. 1-3, the facility to be assessed is equipped with the facility key communicator 22 at the point of service (e.g., near a garage, door entry point, et cetera). When the user arrives at the point of service, the user may manually or automatically initiate wireless communication (e.g., via low power transmission such as for example BLUETOOTH) with the facility key communicator 22. For example, in one embodiment the mobile device 12 transmits its user key 16 to the facility key communicator 22, which then transmits the received user key 16 and its facility key 26 to a remote premise control server 30 via the network 14. The remote premise control server 30 receives both the user key 16 and the facility key 26, and it performs an authentication process on the keys 16, 26 to determine if the user key 12 is associated with a user allowed access and/or control. If the server 30 authenticates the keys 16, 26, then the server transmits access and/or control commands 32 via the network 14 to a premise control client (e.g., a smart lock at the facility to allow the user access to the facility). For example, the remote premise control server 30 may issue an open command to a garage door, to a door lock, and/or issue a command via the network to turn an alarm off, lights on, heat or AC on, temperature set point, et cetera.

In an alternative embodiment, the mobile device 12 may provide the user key 16 and the facility key 26 to the remote premise control server 30. In this embodiment, the facility key communicator 22 continuously or regularly transmits the facility key 26, via for example, lower power wireless transmission such as BLUETOOTH. Low power wireless transmission such as BLUETOOTH is sufficient since the system 10 operates to provide access and control of the facility 24 to an authenticated user proximate to the facility key communicator 22. When close enough, the mobile device 12 receives the facility code 26 and using a mobile app on the device 12 the user may initiate access/control authentication by transmitting the user key 16 and the received facility key 26 from mobile device (e.g., via either the cellular data network or WIFI) to the remote premise control server 30. The remote premise control server 30 receives the keys 16, 26 from the mobile device 12, and performs an authentication process. If the server 30 authenticates the keys 16, 26, then it transmits the access/control commands 32 via the network 14 to the premise control client (e.g., a smart lock) at the facility to allow the user prescribed facility access/control. In this embodiment the requirements for the facility key communicator 22 are relatively simple since it primarily transmits the facility key 26. The user may also initiate the authentication process by using the mobile device 12 to capture an image of the facility code 26 on the display 28 of the facility key communicator 22. The mobile device may then provide its user key to the facility key communicator 22 for transmission to the server 30, or as discussed above with respect to an alternative embodiment, the mobile device 12 may transmit both the user and facility keys 12, 26 to the remote premise control server 30.

In one embodiment, referring to FIG. 1, in response to a demand received by the facility key communicator 22, the communicator 22 may wirelessly transmit the facility key 26 via a low power channel (e.g., BLUETOOTH) to the mobile device 12. The demand may be initiated a number of different ways known in the art, including for example, the facility key communicator 22 receiving a wireless demand from the mobile device 12 or pressing a button on the facility key communicator 22. For security purposes, the mobile device 12 then takes the user key 16 and the received facility key 26 and hashes these (e.g., via an app on the mobile device 12) and transmits the resultant hashed signal to the remote premise control server 30 via the communication channel 14. As set forth above, the user key 16 may be a unique ID for the user (e.g., one or more of the MEI, MEID, ESN or IMSI number, the address, the serial number of the mobile device) or the mobile number assigned by the carrier as a proxy, or a token obtained via prior authentication via a smart app on the device. Once the resultant hashed signal is received by the server 30, the server verifies the authenticity of the user and the facility key pair, and if acceptable, then the server 30 transmits the access/control command(s) 32 via the network 14 to the premise control client (e.g., a smart lock at the facility to allow the user access to the facility). The access/control command 32 transmitted from the server may also be a hashed signal created by hashing a time-of-day stamp and a key associated with the premise control client. Transmitting the time-of-day stamp ensures that the command remains valid for only a certain amount of time (e.g., a few minutes). It is contemplated that encryption may be used rather than a hash function. In addition, it is contemplated that the facility key communicator 22 may always broadcast the facility key, or regularly broadcast the facility key.

The mobile device may also use geofencing to determine or confirm when it is within a prescribed range of the facility key communicator 22, then initiate authentication as set forth above.

For increased security, the facility key communicator 22 may regularly request an updated facility key (e.g., randomly or pseudo randomly generated) from the remote premise control server 30, thus providing a rolling facility key. The requests may occur periodically (e.g., every few minutes) or aperiodically. In response to a request for an updated facility key received via the network 14, the remote premise control server 30 transmits an updated facility key to the facility key communicator 22 via the network 14. Upon receipt of an updated facility key, the facility key communicator 22 stores the updated key 26 and makes it available (e.g., wirelessly and/or visually) as set forth above for authenticated access/control to the facility 24. The regular updating of the facility key increases system security. Rather than the facility key communicating requesting a key update, it is contemplated that the remote premise control server 30 may automatically generate and transmit, periodically or aperiodically, an updated facility key to the facility key communicator 22.

Rather than the remote premise control server 30 generating the updated facility key, it is contemplated that the facility key communicator 22 may generate the updated facility key and send the updated facility key to the remote premise control server 30 via the packet switched network 14 so it is available for authentication.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. An access control method, comprising:
providing a handheld mobile wireless device that includes a user key uniquely associated with a user;
transmitting from a facility communication device, a facility key uniquely associated with the facility;
receiving the facility key at the handheld mobile wireless device;
transmitting the received facility key and the user key from the handheld mobile wireless device;
receiving and authenticating, at a remote premise control server, the received user key and the received facility key;
transmitting an access control command in the event the remote premise control server authenticates the user key and the facility key; and
regularly generating an updated facility key and transmitting the updated facility key from the remote premise control server to the facilities communication device.

2. The method of claim 1, where the transmitting the access control command in the event the remote premise control server authenticates the user key and the facility key comprises transmitting the access control command from the remote premise control server to a smart device at the facility, where the smart device includes at least one of a lock, an alarm and a light.

3. The method of claim 1, where the regularly generating the updated facility key and transmitting the updated facility key from the remote premise control server to the facilities communication device comprises periodically generating the updated facility key.

4. The method of claim 1, where the regularly generating the updated facility key and transmitting the updated facility key from the remote premise control server to the facilities communication device comprises aperiodically generating the updated facility key.

5. The method of claim 1, where the transmitting from the facility communication device of the facility key comprises wirelessly transmitting the facility user key using UHF waves in the BLUETOOTH technology frequency range.

6. The method of claim 5, where the facilities communication device is a battery powered device.

7. The method of claim 1, where the regularly generating the updated facility key and transmitting the updated facility key from the remote premise control server to the facility communication device comprises first the facility communication device sending a facility key update request to the remote premise control server and then the remote premise control server transmitting the updated facility key in response thereto.

8. An access control method, comprising:
providing a handheld mobile wireless device that includes a user key uniquely associated with a user;
transmitting from the facility communication device, a facility key uniquely associated with the facility;
receiving the facility key at the handheld mobile wireless device;
transmitting the received facility key and the user key from the handheld mobile wireless device;
receiving and authenticating, at a remote premise control server, the received user key and the received facility key;
transmitting an access control command in the event the remote premise control server authenticates the user key and the facility key; and
regularly generating an updated facility key and transmitting the updated facility key from the facilities communication device to the remote premise control server.

9. An access control method, comprising:
providing a handheld mobile wireless device that transmits a user key uniquely associated with a user;
receiving, at a facility communication device located at the facility, the user key from the handheld mobile device;
transmitting from the facility communication device, the received user key and a facility key uniquely associated with the facility;
receiving and authenticating, at a remote premise control server, the received user key and the facility key;
transmitting an access control command in the event the remote premise control server authenticates the received user key and the facility key; and
regularly generating an updated facility key and transmitting the updated facility key from the remote premise control server to the facilities communication device.

10. An access control method, comprising:
providing a handheld mobile wireless device that transmits a user key uniquely associated with a user;
receiving, at a facility communication device located at the facility, the user key from the handheld mobile device;
transmitting from the facility communication device, the received user key and a facility key uniquely associated with the facility;
receiving and authenticating, at a remote premise control server, the received user key and the facility key;
transmitting an access control command in the event the remote premise control server authenticates the received user key and the facility key; and
regularly generating an updated facility key and transmitting the updated facility key from the facilities communication device to the remote premise control server.

11. A facility key communicator that cooperates with a mobile device that includes a user key and with a remote premises control server to provide a multi-factor facility access and control system to a facility, the facility key communicator comprising:
a BLUETOOTH wireless transmitter that repeatedly transmits a facility key uniquely associated with the facility; and
a Wi-Fi transceiver that regularly transmits a request for an updated facility key and receives an updated facility key;
where the BLUETOOTH wireless transmitter begins repeatedly transmitting the updated facility key upon the Wi-Fi transceiver receiving the updated facility key.

12. The facility key communicator of claim 11, further comprising a display that visually displays the facility code.

13. A facility key communicator that cooperates with a mobile device that includes a user key and with a remote premises control server to provide a multi-factor facility access and control system to a facility, the facility key communicator comprising:
a display visually displays a facility key uniquely associated with the facility; and
a Wi-Fi transceiver that regularly transmits a request for an updated facility key and receives an updated facility key;
where the display displays the updated facility key upon the Wi-Fi transceiver receiving the updated facility key.
